(19) United States
(12) Patent Application Publication
(10) Pub. No.: US 2026/0169344 A1
(43) Pub. Date: Jun. 18, 2026

(54) OPTICAL CIRCUIT

(71) Applicant: Nippon Telegraph and Telephone Corporation, Tokyo (JP)

(72) Inventors: Shigeru Kanazawa, Musashino-shi, Tokyo (JP); Takahiko Shindo, Musashino-shi, Tokyo (JP); Meishin Chin, Musashino-shi, Tokyo (JP); Shohei Kosuga, Musashino-shi, Tokyo (JP)

(21) Appl. No.: 18/716,063

(22) PCT Filed: Dec. 7, 2021
(86) PCT No.: PCT/JP2021/044967

§ 371 Date: Jun. 3, 2024

(51) Int. Cl. G02F 1/225; G02B 6/12; G02B 6/42; G02F 1/025; G02F 1/035

(52) U.S. Cl. CPC G02F 1/225; G02B 6/12004; G02B 6/4246; G02B 6/4249; G02F 1/025; G02F 1/035

(57) ABSTRACT

Disclosed is an optical circuit having an optimized configuration of a connection substrate that connects between an optical chip including an optical modulator and a wiring board that supplies a high-frequency electrical signal. A wiring board and a light-modulating light source chip are mounted on a subcarrier of the optical circuit. The wiring board and the light-modulating light source chip are connected by a connection substrate, and a high-frequency electrical signal is input to a modulation input electrode from the outside of the optical circuit. A lower limit of a substrate thickness T is set to a value larger than a distance d from a center line of a transmission line to a ground electrode on the same plane. An upper limit of the substrate thickness T of the connection substrate is set to 0.4 mm or less at which substrate resonance does not occur. The connection substrate is made of aluminum nitride, and has a thermal expansion coefficient equivalent to that of the light source chip.

### TECHNICAL FIELD

The present invention relates to a device used in a network. Specifically, the present invention relates to an optical circuit that can be used for high-speed Ethernet or the like.

### BACKGROUND ART

In order to respond to the strong demand for bandwidth accompanying the recent spread of mobile and cloud services, studies on high-speed and large-capacity networks are active. With the advent of the 5G era of wireless communication, a transmission speed of widely used Ethernet of 400 Gbps has already been put into practical use, and Beyond 400G Ethernet has also been studied. In an optical circuit such as an optical transmission/reception module for optical fiber transmission, improvement in performance, miniaturization, and cost reduction are required.

In the Ethernet standards, a miniaturized transceiver (optical transceiver) is standardized, and an optical circuit including an optical modulator is an important device. In order to adapt an optical transmitter to high-speed transmission, flip-chip mounting including an optical chip and a high-frequency signal substrate has been proposed as a mounting structure suitable for high-speed operation.

### CITATION LIST

### Non Patent Literature

Non Patent Literature 1: S. kanazawa et. al., “Flip-Chip Interconnection Lumped-Electrode EADFB Laser for 100-Gb/s/λ Transmitter, ” IEEE Photon. Technol. Lett., vol. 27, no. 16, pp. 1699-1701, 2015.

### SUMMARY OF INVENTION

### Technical Problem

In an optical transmission circuit including an optical modulator of the related art, widening of the bandwidth has been limited due to a high-frequency connection substrate used for flip-chip mounting.

### Solution to Problem

One aspect of the present invention is an optical circuit including: a wiring board that receives a high-frequency electrical signal from the outside; a light source chip including an optical modulator; a subcarrier on which the wiring board and the light source chip are mounted; and a connection substrate that connects between a signal line of the wiring board and a modulation input terminal of the light source chip and has a transmission line in a shape of a coplanar line or a grounded coplanar line, and when a distance from a center line along a length direction of the transmission line to a ground electrode on the same plane as the transmission line is d, a thickness T of the connection substrate satisfies d<T<0.4 (mm).

### Advantageous Effects of Invention

Provided is an optical circuit that is suitable for high-speed operation and includes a miniaturized and widened broadband optical modulator.

### BRIEF DESCRIPTION OF DRAWINGS

FIG. 1 is a diagram illustrating a configuration of an optical circuit of the related art including a light-modulating light source chip.

FIG. 2 is a diagram illustrating a configuration of an optical circuit of Example 1 of the present disclosure including a light-modulating light source chip.

FIG. 3 is a diagram illustrating modulation frequency characteristics of an optical circuit having connection substrates with different substrate thicknesses.

FIG. 4 is a diagram illustrating a configuration of an optical circuit of Example 2 including an optical modulator chip.

FIG. 5 is a diagram illustrating modulation frequency characteristics of an optical circuit having connection substrates with different substrate thicknesses.

### DESCRIPTION OF EMBODIMENTS

An optical circuit of the present disclosure has an optimized configuration of a connection substrate that connects between an optical chip including an optical modulator and a wiring board that supplies a high-frequency electrical signal. The thickness of the connection substrate that improves modulation frequency characteristics of the optical modulator will be clarified. In the following description, first, an optical circuit according to a structure of flip-chip mounting of the related art will be described. Next, the configuration of the connection substrate and the performance of the optical modulator in the optical circuit including the optical modulator of the present disclosure will be described.

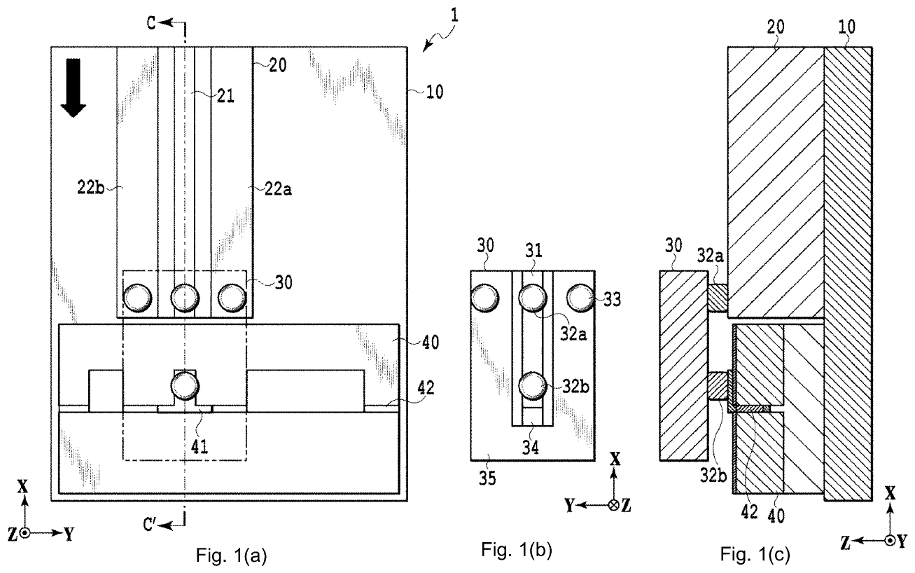

FIG. 1 is a diagram illustrating a configuration of an optical circuit of the related art including a light-modulating light source chip. An optical circuit 1 of FIG. 1 is a component in a module form that can be mounted on a transceiver standardized in the Ethernet, and includes a light-modulating light source chip 40 that is an electro-absorption modulator integrated with DFB laser (EML). A wiring board 20 and the light-modulating light source chip 40 are mounted on a subcarrier 10, and the wiring board 20 and the light-modulating light source chip 40 are connected by a connection substrate 30.

In FIG. 1, (a) illustrates a top view (x-y plane) of the entire optical circuit 1, (c) illustrates a cross-sectional view (x-z plane) of the optical circuit 1 taken along line C-C′, and (b) illustrates a back surface (x-y plane) of the connection substrate 30 mounted on the optical circuit 1. (a) of FIG. 1 illustrates only the four gold bumps between the connection substrate 30 and the light-modulating light source chip 40 and the outline of the connection substrate 30 (double-dot dashed lines) in order to illustrate a connection form with the light-modulating light source chip 40. It should be noted that in the actual optical circuit 1, only the substrate surface or the ground surface of the connection substrate 30 in the top view of (a) of FIG. 1 can be seen depending on the type of the transmission line.

The light-modulating light source chip 40 includes a laser section using an optical waveguide structure 42 configured as an optical semiconductor and an electro-absorption modulator section. A high-frequency electrical signal as a modulation signal is supplied to a modulation input electrode 41 of the light-modulating light source chip 40 via the wiring board 20 and the connection substrate 30. The wiring board 20 includes a signal line 21 formed on a substrate and ground surfaces 22a and 22b on both sides of the signal line, and constitutes a transmission line. The wiring board 20 functions as a high-frequency wiring board that receives a high-frequency electrical signal from the outside and transmits the high-frequency electrical signal without loss.

Referring to (b) of FIG. 1, the connection substrate 30 includes a ground surface 35 surrounding a transmission line 31 and the vicinity thereof on a surface (connection surface) on a side connected by gold bumps. When a coplanar line is used as the transmission line, the substrate material appears as it is on the opposite side of the connection surface, that is, the upper surface in (a) of FIG. 1. When a grounded coplanar line is used as the transmission line, the opposite side of the connection surface is a ground surface.

One end of the transmission line 31 is connected to the signal line 21 of the wiring board 20 via a gold bump 32a. The other end of the transmission line 31 is connected to the modulation input electrode 41 of the light-modulating light source chip 40 via a gold bump 32b. A modulation signal that is a high-frequency electrical signal is input from the outside of the optical circuit 1 in the upper part of (a) of FIG. 1 to the modulation input electrode 41 in the direction of an arrow via the signal line 21 of the wiring board 20 and the transmission line 31 of the connection substrate 30. Also, the ground surfaces of the wiring board 20 and the connection substrate 30 are also electrically and mechanically connected by two gold bumps on both sides of the gold bump 32a. Such a mounting form of electrically and structurally connecting two different substrates 20 and 40 by means of the facing connection substrate 30 and bumps is also known as flip-chip mounting.

The signal line 21 and the transmission line 31 are designed to have an impedance of, for example, 50 Ω in accordance with the signal source impedance of the high-frequency electrical signal supplied from the outside of the optical circuit 1. The connection substrate 30 is made of a material having a thermal expansion coefficient equivalent to that of the light-modulating light source chip 40 so that the connection between the wiring board 20 and the gold bumps 32a and 32b connected to the light-modulating light source chip 40 does not break due to a difference in expansion coefficient due to a temperature change. The structure of flip-chip mounting using the connection substrate 30 in FIG. 1 does not require a wire for connection between the wiring board 20 and the light-modulating light source chip 40, and thus, is useful for broadening the bandwidth of the light modulation characteristics.

However, in the optical circuit of the related art in FIG. 1, there may be a problem that the extension of the bandwidth in the modulation frequency characteristics of the optical modulator is insufficient and a problem that ripples occur in the modulation band.

In general, in a coplanar line and a grounded coplanar line, characteristic impedance is determined by a structure of a connection surface side and a back surface of the connection surface side constituting a transmission line and parameters of a material. These parameters include the width of the transmission line, the distance to the ground surfaces on both sides of the transmission line, the thickness of the transmission line metal, the dielectric constant of the substrate material, the thickness of the substrate, the distance between the transmission line and the back ground, and the like. Normally, when the thickness of the connection substrate 30 is larger than about 2 times the transmission line width or the distance from the transmission line to the ground surface, the thickness of the substrate should not affect the characteristic impedance. However, it has not been clarified specifically whether the substrate thickness of the connection substrate 30 has any effect on the modulation characteristics of the optical modulator. The inventors have paid attention to the influence of the thickness T of the connection substrate 30 on the modulation frequency characteristics of the optical modulator, and have clarified a more appropriate range of the substrate thickness T from the relationship with the modulation frequency characteristics of the optical modulator.

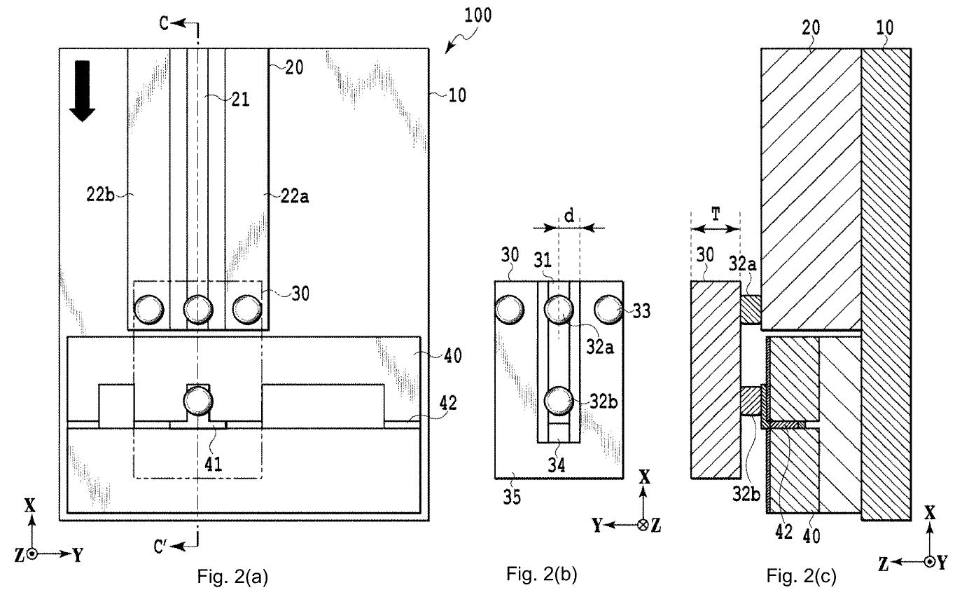

FIG. 2 is a diagram illustrating a configuration of an optical circuit of the present disclosure including a light-modulating light source chip. An optical circuit 100 of FIG. 2 has a form of a subassembly that can be mounted, for example, on a substrate such as an Ethernet transceiver or an optical transmission device. In FIG. 2, (a) illustrates a top view (x-y plane) of the entire optical circuit 100, (c) illustrates a cross-sectional view (x-z plane) of the optical circuit 100 taken along line C-C′, and (b) illustrates a back surface (x-y plane) of a connection substrate 30 mounted on the optical circuit. In the optical circuit 100, similarly to the optical circuit 1 of the related art illustrated in FIG. 1, a wiring board 20 and a light-modulating light source chip 40 are mounted on a subcarrier 10. Similarly to the optical circuit 1, the wiring board 20 and the light-modulating light source chip 40 are connected by a connection substrate 30, and a high-frequency electrical signal is input to a modulation input electrode 41 from the outside of the optical circuit 100. In addition, a transmission line (signal line) leading to the light source chip 40 via the wiring board 20 and the connection substrate 30, and a connection form on the ground are also the same as those in FIG. 1.

A difference from the optical circuit 1 of the related art illustrated in FIG. 1 is that, in the connection substrate 30 illustrated in (b) of FIG. 2, the relationship between a distance d from a center line along the length direction of a transmission line 31 to a ground surface 35 and a substrate thickness T of the connection substrate 30 is defined. Here, the material of the connection substrate 30 is aluminum nitride, and the characteristic impedance of the transmission line is 50 Ω, which is common in high frequency systems. The lower limit of the substrate thickness T is set to a value larger than the distance d from the center line of the transmission line to the ground electrode on the same plane so that the characteristic impedance of the transmission line 31 does not deviate from the characteristic impedance of the system. Further, the upper limit of the substrate thickness T of the connection substrate 30 is set to 0.4 mm or less at which substrate resonance does not occur. Hereinafter, a specific configuration example will be described as Example 1.

Therefore, the optical circuit of the present disclosure can be implemented on the assumption that the optical circuit includes a wiring board 20 that receives a high-frequency electrical signal from the outside, a light source chip 40 including an optical modulator, a subcarrier 10 on which the wiring board and the light source chip are mounted, and a connection substrate 30 that connects between a signal line 21 of the wiring board and the modulation input terminal 41 of the light source chip and has a transmission line 31 in a shape of a coplanar line or a grounded coplanar line, and when a distance from a center line along a length direction of the transmission line to a ground electrode 35 on the same plane as the transmission line is d, a thickness T of the connection substrate satisfies d<T<0.4 (mm).

### Example 1

An optical circuit of Example 1 including a light-modulating light source chip (light source chip) was produced according to the structure illustrated in FIG. 2. The optical circuit has a form of a subassembly that can be mounted, for example, on a substrate such as an Ethernet transceiver. The light-modulating light source chip 40 is an EML in which optical semiconductor modulators including an optical waveguide structure are integrated, and the electrode length of the electro-absorption modulator (EA modulator) was set to 75 μm. An InP substrate is used as a substrate material of the light-modulating light source chip 40. The width of the transmission line 31 of the connection substrate 30 was set to 0.08 mm, and the distance d from the center line along the length direction of the transmission line 31 to the ground electrode 35 was set to 0.08 mm. The ground electrodes 35 on both sides have symmetrical structures equidistant from the center line. The material of the connection substrate 30 was aluminum nitride. Here, in order to compare modulation characteristics depending on the thickness T of the connection substrate 30, a plurality of optical circuits were produced using different substrates in which T was changed to 0.05 to 0.75 mm at intervals of 0.1 mm.

In all the produced optical circuits, the gold bumps 32a, 32b, and 33 used for connection between the connection substrate 30 and the wiring board 20 and the light-modulating light source chip 40 had a diameter of 60 μm and a height of 30 μm.

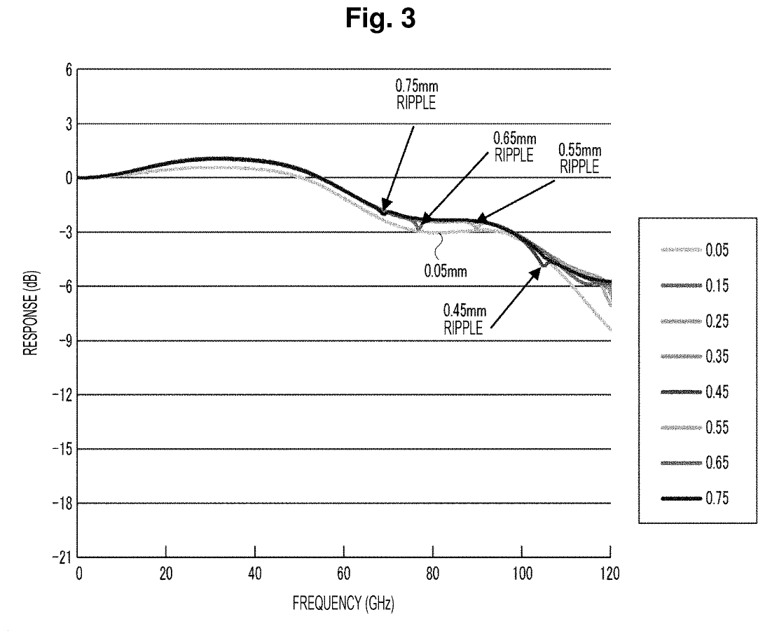

FIG. 3 is a diagram illustrating modulation frequency characteristics in an optical circuit having connection substrates with different substrate thicknesses. The horizontal axis indicates the modulation frequency (GHz), and the vertical axis indicates the frequency response of the modulation output characteristics normalized at a level near the direct current in dB. The modulation frequency characteristics of nine types of optical circuits having the above-described different substrate thicknesses T=0.05 to 0.75 (0.1 intervals) mm are compared and illustrated. In the case of T=0.05 mm, since the characteristic impedance of the transmission line 31 decreases, the response level in the high frequency region decreases, and the modulation frequency characteristics are deteriorated as a whole. When the substrate thickness T is 0.15 mm or more, the outlines of the modulation frequency characteristics are almost the same and overlap regardless of the value of T, and it is not possible to clearly distinguish them. However, at certain frequencies, a ripple with a sudden change in level was observed. Specifically, at T=0.45, 0.55, 0.65, and 0.75 mm, ripples due to substrate resonance occur at frequencies around 105, 90, 77, and 69 GHz, respectively. On the other hand, in the case of T=0.15, 0.25, and 0.35 mm of 0.4 mm or less, the ripple of the frequency response characteristics is not observed.

From the modulation frequency characteristics with the substrate thickness T as a parameter illustrated in FIG. 3, it is sufficient that the lower limit of the substrate thickness T of the connection substrate 30 is larger than the distance d (0.08 mm) between the center along the length direction of the transmission line and the ground electrode on the same plane. In addition, the upper limit of the substrate thickness T of the connection substrate 30 is 0.4 mm or less in which no ripple occurs in the modulation frequency characteristics, and the modulation frequency characteristics without degradation can be stably obtained within the range of the upper limit and the lower limit.

As described above, it has been confirmed that when the thickness T of the connection substrate 30 is too thin, the characteristic impedance of the transmission line of the connection substrate 30 changes deviating from the characteristic impedance of the system (50 Ω in the present example), and even when T is too thick, the modulation frequency characteristics are deteriorated due to resonance inside the substrate. An appropriate range of the thickness T of the connection substrate was also confirmed for a configuration of an optical circuit including another light source chip including a Mach-Zehnder interferometric modulator (MZ modulator) in the following Example 2.

### Example 2

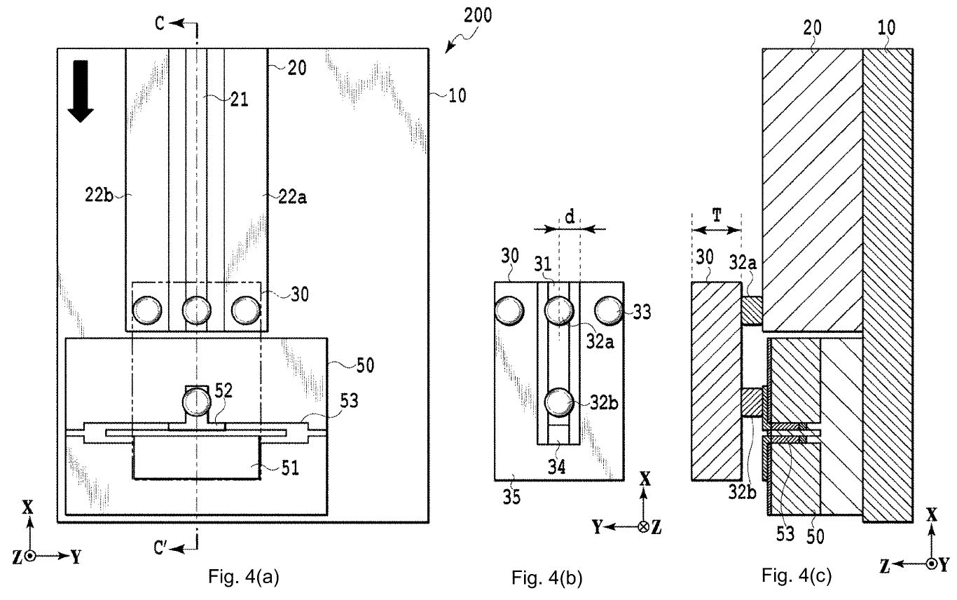

FIG. 4 is a diagram illustrating a configuration of an optical circuit of Example 2 including a light-modulating light source chip. The optical circuit of Example 2 has a form of a subassembly 200 that can be mounted, for example, in an Ethernet transceiver or on a package such as an optical transmission device. In FIG. 4, (a) illustrates a top view (x-y plane) of the entire optical circuit 200, (c) illustrates a cross-sectional view (x-z plane) of the optical circuit 200 taken along line C-C′, and (b) illustrates a back surface (x-y plane) of a connection substrate 30 mounted on the optical circuit. The optical circuit 200 of Example 2 has an optical modulator chip (light source chip) 50 including only a Mach-Zehnder interferometric modulator (MZ modulator) 53 without including a light source, instead of the light-modulating light source chip 40 of Example 1. As can be seen from the cross-sectional view of (c) of FIG. 4, the MZ modulator 53 configured in the optical modulator chip 50 has two arm waveguide structures. A modulation input electrode 52 (P-side electrode) as an input terminal of a high-frequency electrical signal is formed on one arm waveguide, and a P-side electrode 51 for phase adjustment is formed on the other arm waveguide.

A wiring board 20 and an optical modulator chip 50 are connected by the connection substrate 30, and a high-frequency electrical signal is input to the modulation input electrode 52 from the outside of the optical circuit 200, and a transmission line (signal line) leading to the optical modulator chip 50 via the wiring board 20 and the connection substrate 30 and a connection form of the ground are the same as those in Example 1.

In the MZ modulator of the optical modulator chip 50, the electrode length of the modulator was set to 100 μm. An InP substrate is used as a substrate material of the optical modulator chip 50. At this time, the width of the transmission line 31 of the connection substrate 30 was set to 0.08 mm, and the distance d from the center line along the length direction of the transmission line 31 to the ground electrode 35 was set to 0.08 mm. The ground electrodes 35 on both sides have symmetrical structures equidistant from the center line. The material of the connection substrate 30 was aluminum nitride. Here, in order to compare modulation characteristics depending on the thickness T of the connection substrate 30, similarly to the case of Example 1, a plurality of optical circuits were produced using different substrates in which T was changed in a range of 0.05 to 0.75 mm at intervals of 0.1 mm.

In all the produced optical circuits, the gold bumps 32a, 32b, and 33 used for connection between the connection substrate 30 and the wiring board 20 and the light-modulating light source chip 40 had a diameter of 60 μm and a height of 30 μm.

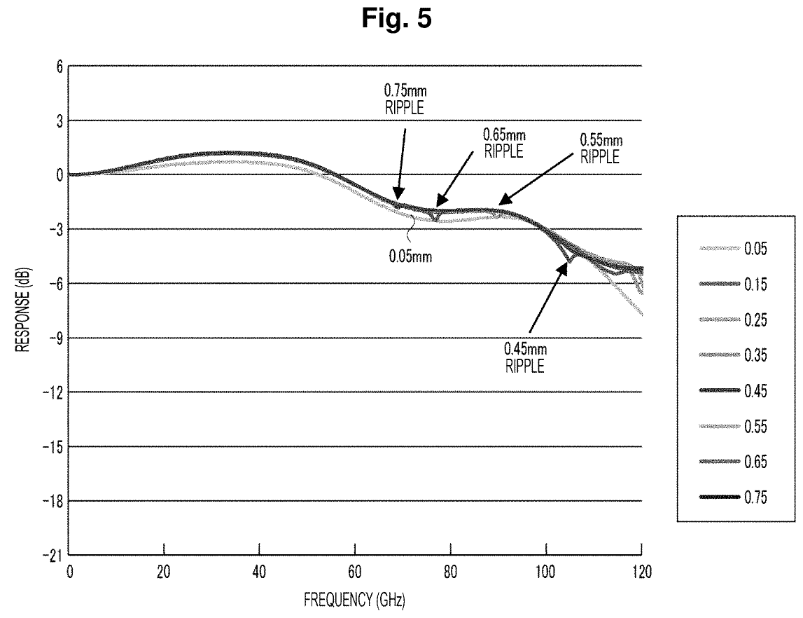

FIG. 5 is a diagram illustrating modulation frequency characteristics in an optical circuit having connection substrates with different substrate thicknesses. The horizontal axis indicates the modulation frequency (GHz), and the vertical axis indicates the frequency response of the modulation output characteristics normalized at a level near the direct current in dB. The modulation frequency characteristics of nine types of optical circuits having the above-described different substrate thicknesses T=0.05 to 0.75 (0.1 intervals) are compared and illustrated. Roughly similar to the modulation frequency characteristics of Example 1 illustrated in FIG. 3, FIG. 5 illustrates the dependence of the modulation frequency characteristics depending on the substrate thickness T.

In the case of T=0.05 mm, since the characteristic impedance of the transmission line 31 decreases, the response level in the high frequency region decreases, and the modulation frequency characteristics are deteriorated as a whole. When the substrate thickness T is 0.15 mm or more, the outlines of the modulation frequency characteristics are almost the same and overlap regardless of the value of T, and it is not possible to clearly distinguish them. However, at certain frequencies, a ripple with a sudden change in level was observed. Specifically, at T=0.45, 0.55, 0.65, and 0.75 mm, ripples due to substrate resonance occur at frequencies around 105, 90, 77, and 69 GHZ, respectively. On the other hand, in the case of T=0.15, 0.25, and 0.35 mm of 0.4 mm or less, the ripple of the modulation frequency characteristics is not observed.

Also from the modulation frequency characteristics with the substrate thickness T as a parameter illustrated in FIG. 5, it is sufficient that the lower limit of the substrate thickness T of the connection substrate 30 is made larger than the distance d (0.08 mm) between the center along the length direction of the transmission line and the ground electrode on the same plane. It is also sufficient that the upper limit of the substrate thickness T of the connection substrate 30 is set to 0.4 mm or less at which no ripple occurs in the modulation frequency characteristics. It has been confirmed that even when the optical modulator chip 50 includes the MZ modulator 53, modulation frequency characteristics without deterioration can be stably obtained within the above upper limit and lower limit range of the substrate thickness T of the connection substrate 30.

As described above in detail, the optical circuit of the present disclosure achieves widened broadband and miniaturization of a device including an optical modulator in Ethernet or the like.

### Industrial Applicability

The present invention can be used for a network device for optical communication.

1. An optical circuit comprising:
a wiring board that receives a high-frequency electrical signal from the outside;
a light source chip including an optical modulator;
a subcarrier on which the wiring board and the light source chip are mounted; and
a connection substrate that connects between a signal line of the wiring board and a modulation input terminal of the light source chip and has a transmission line in a shape of a coplanar line or a grounded coplanar line, wherein
when a distance from a center line along a length direction of the transmission line to a ground electrode on the same plane as the transmission line is d, a thickness T of the connection substrate satisfies d<T<0.4 (mm).

2. The optical circuit according to claim 1, wherein the connection substrate is made of aluminum nitride, and has a thermal expansion coefficient equivalent to that of the light source chip.

3. The optical circuit according to claim 1, wherein a material of the light source chip is an InP substrate.

4. The optical circuit according to claim 1, wherein the signal line and the transmission line are matched to a characteristic impedance of 50 Ω.

5. The optical circuit according to claim 1, wherein bumps connect between the signal line and the transmission line and between the transmission line and the modulation input terminal, respectively.

6. The optical circuit according to claim 1, wherein the light source chip is an electro-absorption modulator, a Mach-Zehnder interferometric modulator, or a directly modulated laser.

7. The optical circuit according to claim 2, wherein a material of the light source chip is an InP substrate.

8. The optical circuit according to claim 2, wherein the signal line and the transmission line are matched to a characteristic impedance of 50 Ω.

9. The optical circuit according to claim 3, wherein the signal line and the transmission line are matched to a characteristic impedance of 50 Ω.

10. The optical circuit according to claim 2, wherein bumps connect between the signal line and the transmission line and between the transmission line and the modulation input terminal, respectively.

11. The optical circuit according to claim 3, wherein bumps connect between the signal line and the transmission line and between the transmission line and the modulation input terminal, respectively.

12. The optical circuit according to claim 4, wherein bumps connect between the signal line and the transmission line and between the transmission line and the modulation input terminal, respectively.

13. The optical circuit according to claim 2, wherein the light source chip is an electro-absorption modulator, a Mach-Zehnder interferometric modulator, or a directly modulated laser.

14. The optical circuit according to claim 3, wherein the light source chip is an electro-absorption modulator, a Mach-Zehnder interferometric modulator, or a directly modulated laser.

15. The optical circuit according to claim 4, wherein the light source chip is an electro-absorption modulator, a Mach-Zehnder interferometric modulator, or a directly modulated laser.

16. The optical circuit according to claim 5, wherein the light source chip is an electro-absorption modulator, a Mach-Zehnder interferometric modulator, or a directly modulated laser.
